(19) United States
(12) Patent Application Publication
(10) Pub. No.: US 2018/0257349 A1
(43) Pub. Date: Sep. 13, 2018

(54) MULTIFUNCTIONAL PAPERBOARD STRUCTURE

(71) Applicant: WestRock MWV, LLC, Atlanta, GA (US)

(72) Inventors: Rahul Bhardwaj, Glen Allen, VA (US); Chitai C. Yang, Mechanicsville, VA (US); Chester E. Alkiewicz, Glen Allen, VA (US); Matthew S. Cameron, Covington, VA (US)

(21) Appl. No.: 15/969,157

(22) PCT Filed: Nov. 3, 2016
(86) PCT No.: PCT/US2016/060219

§ 371 Date: May 2, 2018

Related U.S. Application Data
(60) Provisional application No. 62/249,990, filed on Nov. 3, 2015.

(51) Int. Cl. B32B 27/10; B32B 27/08; B32B 27/30; B32B 27/32; B32B 27/34; B32B 27/36; B32B 29/06; B32B 7/12; D21H 11/04; D21H 19/22; D21H 19/28; D21H 19/30; D21H 19/40; D21H 19/82; D21H 19/84; D21H 27/10

(52) U.S. Cl. CPC B32B 27/10; B32B 2554/00; B32B 27/308; B32B 27/32; B32B 27/34; B32B 27/36; B32B 29/06; B32B 7/12; D21H 11/04; D21H 19/22; D21H 19/28; D21H 19/30; D21H 19/40; D21H 19/824; D21H 19/84; D21H 27/10; B32B 2255/12; B32B 2255/26; B32B 2307/31; B32B 2307/518; B32B 2307/5825; B32B 2307/75; B32B 2439/00; B32B 27/08

(57) ABSTRACT

A multi-layer paperboard structure may be heat sealed to form a packaging material. The paperboard structure exhibits good sealing strength and improved anti-blocking behavior. The structure may be self-sealed or sealed to plastic blister materials.

### REFERENCE TO RELATED APPLICATIONS

This application is a National Phase application of PCT Application PCT/US2016/060219, filed Nov. 3, 2016, which claims the benefit of U.S. Provisional Patent Application No. 62/249,990, filed Nov. 3, 2015, both of which are incorporated herein by reference in their entirety.

### BACKGROUND OF THE INVENTION

The present invention relates to a multi-layer paperboard structure that may be heat sealed to form a tear resistant packaging material. Use of heat sealable paperboard materials for packaging is described, for example, in U.S. Pat. No. 5,091,261 (Casey et al.). This patent describes a laminate for packaging applications comprised of a paperboard substrate having one coated, printable surface (C1S), and having adhered to the opposing side a co-extrudate of low density polyethylene and an adhesive material, for example, ethylene methyl-acrylate copolymer. This adhesive material enables the laminate to be used for applications such as the manufacture of blister cards, which requires that a tight seal be formed between the laminate and the plastic material of the blister. In this regard, the adhesive material is a heat sealable component that plasticizes at low heat, so that when opposing surfaces treated with the same material are contacted, the adhesive material bonds together to form a seal.

U.S. Pat. No. 6,010,784 relates to a paperboard laminate, where an ethylene-vinyl acetate (EVA) based hot melt forms the sealant layer, for pharmaceutical blister packaging. The hot melt layer seals to common blister forming films including polychlorotrifluoroethylene (Aclar®), a high barrier film.

The packaging laminates described in U.S. Pat. Nos. 5,091,261 and 6,010,784 exhibit the additional advantage of being clay-coated and thus printable on one side. Accordingly, they are suited to consumer packaging applications, for example, for packaging of unit dose pharmaceuticals. However, these products lacked high tear resistance and burst resistance, which are both characteristics desired for various packaging applications including but not limited to pharmaceutical packaging.

A tear resistant heat sealable paperboard is disclosed in commonly assigned U.S. Pat. No. 7,144,635 issued on Dec. 5, 2006 and commonly owned by the Applicant.

While such packaging material with heat sealing ability is particularly well suited to secure packaging of consumable goods, the heat sealable material may sometimes exhibit unwanted characteristics. When rolls of such paperboard are stored for long periods of time, the layers may “block” (stick together), even to the extent that entire rolls may be useless. Also, the constituents of the heat sealing material may transfer to the printable surface, causing mottling or other print defects. It is desired therefore to have a heat sealable packaging material that does not exhibit blocking or print-side degradation. These objectives are met by the various embodiments of the tear resistant packaging material described and claimed herein.

### BRIEF SUMMARY OF THE INVENTION

The invention is directed to a method of making a laminate formed from a paper or paperboard substrate. An adhesive layer is applied to the substrate. A tear resistant material may be secured to the substrate by the adhesive. A heat sealing layer is secured to the tear resistant material. The heat sealing layer is designed to prevent blocking and avoid material transfer to the printing side of the paperboard substrate.

### BRIEF DESCRIPTION OF THE DRAWINGS

FIG. 1A is a schematic representation of a cross section of a heat sealable laminate;

FIG. 1B is a simplified diagram of a process for making a heat sealable laminate;

FIG. 2A is a schematic representation of a cross section of a prior-art heat sealable laminate;

FIG. 2B is a schematic representation of a cross section of a prior-art heat sealable laminate;

FIG. 3A is a schematic representation of a cross section of a heat sealable laminate according to a first embodiment of the invention;

FIG. 3B is a schematic representation of a cross section of a heat sealable laminate according to a second embodiment of the invention;

FIG. 4 is a schematic representation of a cross section of a heat sealable laminate according to a third embodiment of the invention;

FIG. 5 is a schematic representation of a cross section of a heat sealable laminate according to a fourth embodiment of the invention;

FIG. 6 is a perspective view of an extrusion coating process;

FIG. 7 is a front view of an extruded coating being applied to paperboard;

FIG. 8 is an illustration of a device for testing blocking of coated paperboard samples;

FIGS. 9A-9D illustrate a peel test method; and

FIGS. 10A-10B illustrate a water contact angle measurement.

### DETAILED DESCRIPTION OF THE INVENTION

The invention provides a packaging material that is resistant to tearing or burst damage and thus provides more security to the package contents when it is used, for example, to form a folded box, envelope, blister card or other package. This feature is particularly desirable in the foldover blister packaging of pharmaceuticals where regulatory guidelines specify a certain acceptable level of child resistance. At the same time, the package must be user-friendly, fitted to frequent repeat usage and easily manipulated by the consumer.

The laminated structure of the present invention comprises one or more materials that, in combination, produce the heat sealable laminate that resists blocking and material transfer between layers.

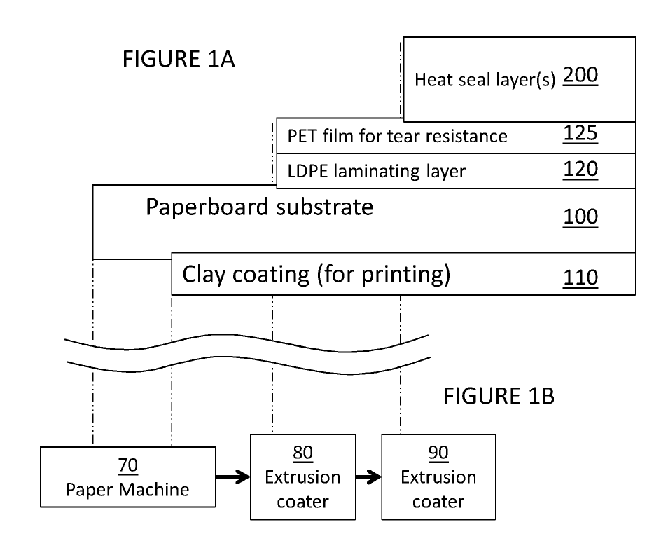

As shown in FIG. 1A, the substrate material 100 may be selected from any conventional paperboard grade, for example solid bleached sulfate (SBS) or uncoated natural kraft (UNC) or coated natural kraft (CNK) ranging in caliper upward from about 10 pt. to about 30 pt. An example of such a substrate is a 16-point SBS board manufactured by WestRock Company. The substrate 100 may also be an unbleached board, depending on the desired appearance of the final package. The board 100 may be made on a paper machine 70 (symbolically represented in FIG. 1B) and is preferably coated on at least one side, preferably the side opposite the lamination, with a conventional coating 110 selected for compatibility with the printing method and board composition. The coated side would typically be present on the external surface of the package to allow for printing of text or graphics. The coating may be done by a coater as part of a paper machine 70, or on a separate coater. The printable coating is optional.

An adhesive layer or laminating layer 120 may be applied to an uncoated side of the paper or paperboard substrate 100. The laminating layer 120 may be a polyolefin material like low density polyethylene (LDPE). The laminating layer 120 is optional.

An optional tear resistant layer 125 such as polymeric material may be placed in contact with the laminating layer and thus secured to the paper of paperboard substrate. The tear resistant layer imparts toughness to the laminate structure. Suitable tear resistant materials to include n-axially oriented films, e.g. MYLAR™, which is a biaxially oriented polyester, oriented nylon, e.g. DARTEK™, cross-laminated polyolefin film, e.g. VALERON™ or INTEPLUS™, which are high density polyolefins. The orientation and cross-laminated structure of these materials contribute to the tear resistant characteristic. Also, tear resistance may be attributed to the chemical nature of the tear resistant material such as extruded metallocene-catalyzed polyethylene (mPE). The laminating layer 120 and the tear resistant layer 125 may be laminated to substrate 100 applied using an extrusion coater 80 or other suitable processing method. Alternatively, the tear resistant layer 125 may be an extrusion-coated layer, such as LLDPE or mPE. In embodiments where linear low-density polyethylene (LLDPE) or mPE is used, however, it is not necessary to incorporate the laminating layer 120. Other suitable materials having a high level of tear resistance may also be used. The tear resistant layer is optional.

Where a sheet material such as oriented polyester or nylon or cross-laminated is used as the tear resistant layer 125, a caliper for the tear resistant layer ranging from about 0.75 mils (approximately 16 lb/ream) or more is preferred. As used herein, ream size equals 3000 ft.sup.2. For example, a suitable caliper of tear resistant material 125 may range from about 0.75 mils or more, preferably from about 1 mil to about 5 mils.

Finally, a heat seal layer or layers 200 may be applied to the tear resistant layer by a process 90 such as melt extrusion. The heat seal layer 200 serves as convenient means of forming packages from the laminate. When heated, the heat seal layer forms an adhesive when contacted with other regions of the laminate. Examples of suitable heat seal material include ethylene vinyl acetate (EVA), ethylene methyl acrylate (EMA) copolymers, or combinations thereof. Preferably, the heat seal layer is applied by melt extrusion. A suitable coat weight is from about 5 pounds per 3,000 square feet to about 14 pounds per 3,000 square feet, preferably about 8 to 12 pounds per 3,000 square feet. The process of FIG. 1 is described in detail in U.S. Pat. No. 5,091,261, the entire disclosure of which is incorporated herein by reference.

In a preferred embodiment of the invention, a laminate structure is formed in an in-line operation by unwinding a C1S paperboard substrate 100, extruding a polymer melt of LDPE laminating layer 120 to the substrate 100 and securing a tear resistant material 125 onto the polymer melt. A layer of a heat seal material 200 such as a combination of LDPE and ethyl methyl acrylate (EMA) is extruded over the tear resistant material 125. The sealant layer 200 may be a single component EVA. Alternatively, both the tear resistant layer 125 and the heat seal material 200 may be co-extruded. In such an application, a chemically strengthened material such as mPE, which may be extruded without compromise to its strength characteristics, is used as the tear resistant layer 125.

The resulting flexible, laminated structure of the invention may be used in any packaging application where tear resistance is required. One of many such applications is the packaging of pharmaceuticals such as prescription medications. In one exemplary application, the laminate may be used to form the outer packaging of a box housing unit dose medications. In such an embodiment, the medications may be housed in individual doses on a blister card that is contained within the box interior. Packaging of other articles such as dry or semi-moist foods, cosmetics, small electronics, recording media such as CDs and tapes and various other articles are also contemplated and should be viewed as falling within the scope of this disclosure. The laminate structure of the invention may, however, also be manufactured using a lighter weight paperboard substrate or even a paper, for example, envelope grade material, to manufacture other types of containers such as envelopes or mailers. The range of potential applications is therefore quite extensive for this versatile composition.

Although tear resistance is often useful for various applications, the tear resistant layer 125 is optional and certain benefits of the laminated structure, such as improved sealing and reduced blocking may be possible even without a tear resistant layer.

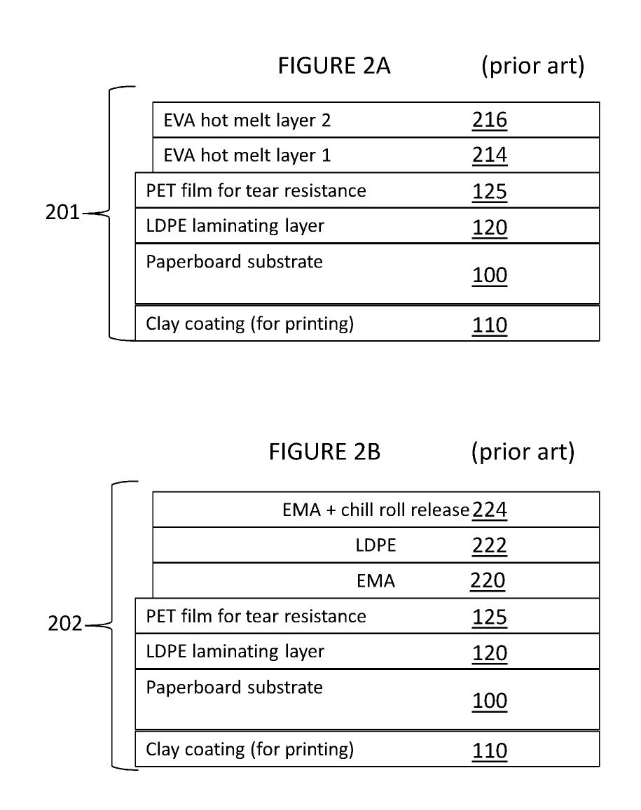

FIG. 2A shows an example of a heat-sealable, tear-resistant material 201 where the heat sealable layers include a first hot melt layer 214 adjacent the tear resistant layer 125, and a second hot melt layer 216 upon the first hot melt layer 214. Examples of extrudable hot melt materials include LOCTITE LIOFOL HS E4050DST and TECHNOMELT HM1111B, both made by Henkel Corporation. The material 201 provides good tear resistance and heat sealability at relatively low temperatures, but when rolls of this material are stored or shipped over prolonged time, the rolls may exhibit blocking (layers stick together) or material transfer (traces of hot melt material transferring to the clay coating, resulting in print mottle or other print defects). An alternate heat-sealable, tear-resistant material 202 with better resistance to blocking and print mottling is shown in FIG. 2B, which utilizes for the heat sealable layers: an EMA layer 220 adjacent the tear resistant layer 125, followed by a LDPE layer 222, and then an EMA layer 224 with a chill roll release agent. However, this material 202 has poor heat sealability to blisters, and has a high coefficient of friction (COF).

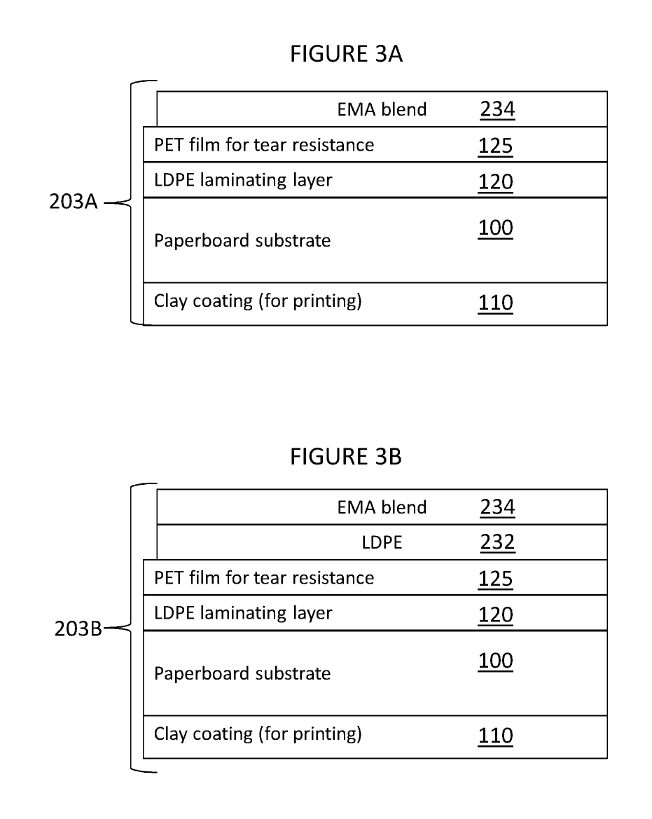

FIG. 3A shows a heat-sealable, tear-resistant structure 203A where the heat sealing layer is an EMA blend 234 of two different EMAs with optional processing aids such as chill roll release agents.

FIG. 3B shows a heat-sealable, tear-resistant structure 203B where the heat sealing layers include an LDPE layer 232, followed by an EMA blend 234 of two different EMAs with optional processing aids such as chill roll release agents.

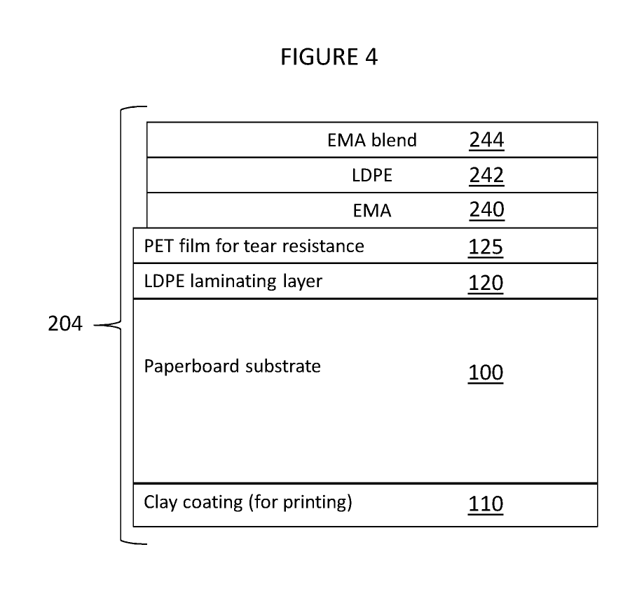

FIG. 4 shows a heat-sealable, tear-resistant structure 204 where the heat sealing layers include an EMA layer 240, followed by an LDPE layer 242, followed by an EMA blend 244 of two different EMAs with optional processing aids such as chill roll release agents.

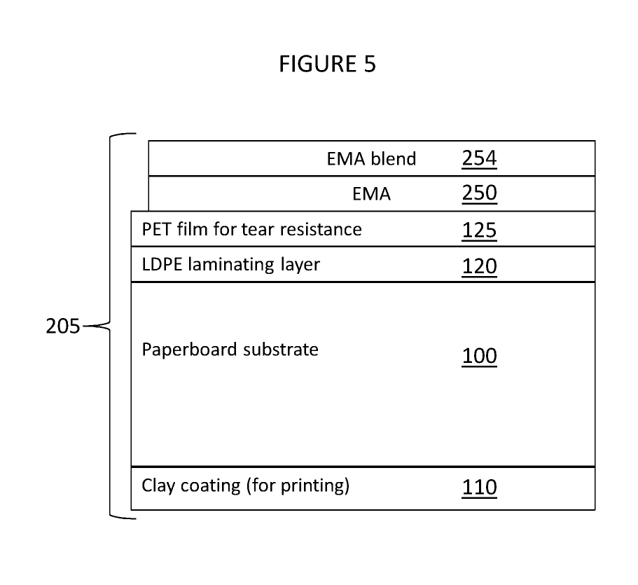

FIG. 5 shows a heat-sealable, tear-resistant structure 205 where the heat sealing layers include an EMA layer 240, followed by an EMA blend 244 of two different EMAs with optional processing aids such as chill roll release agents.

The structures shown in certain of FIGS. 3A, 3B, 4, and 5 will be described further in the following discussion. It should be understood that some of the elements in the Figures may be optional. For example, with respect to FIG. 5, it should be understood that the clay coating 110 (for printing) may be optional. The tear resistant film 125 may be optional, and if not used, the laminating layer 120 may not be used. With certain EMA blends 254, the EMA layer 250 may be optional. In certain applications, it is contemplated that a useful heat sealable and blocking resistant structure might be achieved using only a suitable EMA blend layer 254 and a paperboard substrate 100.

The layers 232, 240, and 250 in FIGS. 3B, 4, and 5 respectively may be considered as tie layers, and as such may comprise tie resins. Tie resins may include, for example, EMA copolymers, functionalized EMA, LDPE, and functionalized polyolefins.

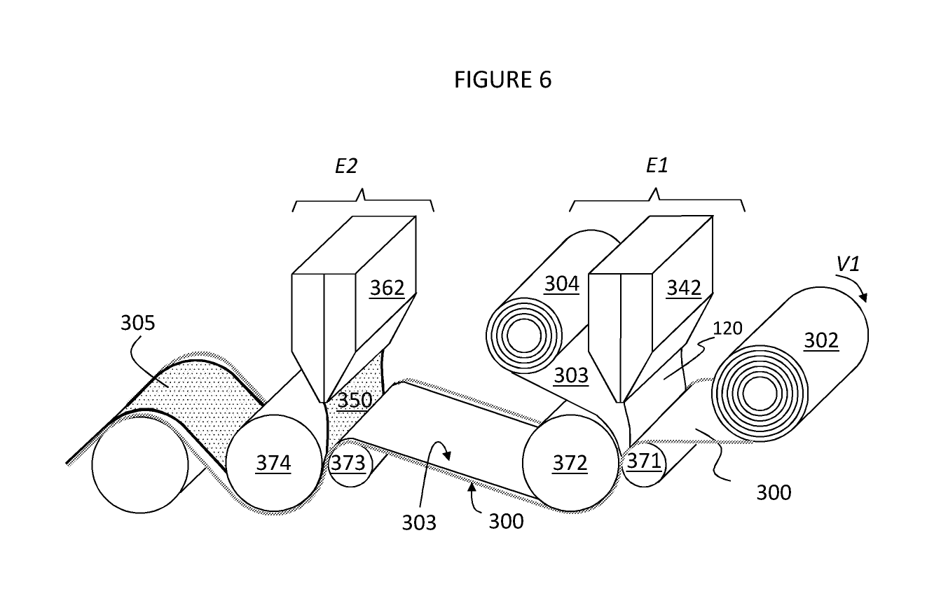

FIG. 6 shows a simplified drawing of an example process for applying a heat sealable layer onto a paperboard substrate. A paperboard substrate 300 is unrolled at a linear speed V1 from feed roll 302. At a first extrusion coater E1, extruder die 342 applies a curtain 120 of a laminating layer 120 such as LDPE plastic between paperboard substrate 300 and a film 303 of PET being unwound from roll 304. The paperboard 300, laminating layer 120, and PET film 303 are pressed together in a nip between pressure roll 371 and chill roll 372 which may cool the plastic before the paperboard 300/PET 303 moves to the next step of the process.

At a second extrusion coater E2, extruder die 362 applies a curtain 350 of plastic onto the PET 303 surface of the PET 303/paperboard substrate 300. The PET-coated paperboard substrate 300 and the curtain 350 are pressed together in a nip between pressure roll 373 and chill roll 374 that cools the structure before the coated paperboard 305 moves on. The process at the second extruder E2 is the general focus of most of the remaining discussion.

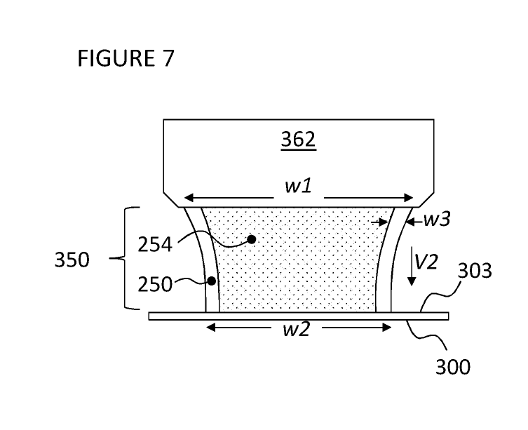

FIG. 7 shows a front view of the extrusion coating process at the second extrusion coater. On leaving the extruder die 362, the curtain 350 of plastic may have a width w1 that may depend on processing conditions including composition, temperature, and feed rate of the plastic, slot opening in the extruder die, and position of deckle rods within the die. Also dependent on these factors is the linear speed V2 of curtain 350. If the slot opening is T1 mils, the resulting film thickness T2 of the plastic on the coated paperboard 305 will be approximately T1*V2/V1 mils. Usually the paperboard speed V1 will be several times greater than the curtain speed V2, and the film thickness T2 will correspondingly be several times less than T1.

The curtain 350 as it leaves the extruder die 362 may have an initial width w1 but may ‘neck down’ to a lesser width w2 as it is applied to the PET 303/substrate 300. The neck-down calculated as a percentage is equal to 100%*(w1−w2)/w1.

When curtain 350 is made of multiple layers of coextruded material, such as the EMA layer 250 and the EMA blend layer 254 (as seen in FIGS. 5 and 7) a phenomenon known as “edge encapsulation” may occur, where one of the layers (here the EMA layer 250) is wider than the other layer (here the EMA blend layer 254). The edge encapsulation is measured as the distance w3 between the edges of the two layers. If the two layers are visually different—as with a somewhat opaque EMA blend layer 254 and a clear EMA layer 250—then the edge encapsulation is readily measured. Any edge encapsulation results in waste product since the edges of the substrate coated with the incomplete (one layer) film will be scrapped.

Another processing defect that sometimes occurs and causes waste material is ‘edge weave,’ where the edges of the curtain of plastic waver sideways. With non-uniform coverage at the edges, more of the sides of the substrate need to be trimmed as waste.

Examples of materials used in the various structures are given in Table 1. A “name” or “EMA copolymer name” is given that is used for simplicity in the following descriptions. Certain of the materials are commercially available and are denoted by their trade names.

TABLE 1
Specific Materials

| Name | Chemistry | Description |
|---|---|---|
| Laminating resin | low density polyethylene (LDPE) | LyondellBasell |
| | | Petrothene |
| | | NA217000 |
| Chill Roll Release (CRR) | chill roll release with polyethylene | Ampacet 10451 |
| | carrier. Polyethylene glycol as active | |
| | ingredient (0-1%) | |
| Modified EMA | Modified ethyl methyl acrylate | DuPont ™ |
| | copolymer (modified EMA) | APPEEL ® 20D828 |

| EMA Copolymer Name | Percent methacrylate | Melt index* |
|---|---|---|
| First EMA copolymer | EMA with 24% methacrylate | 5.0 gram/10 min |
| Exxon Optema ™TC220 | | |
| Second EMA copolymer | EMA with 20% methacrylate | 6.0 gram/10 min |
| Westlake EMAC ® SP2207 | | |
| Third EMA copolymer | EMA with 24% methacrylate | 2.1 gram/10 min |
| Westlake EMAC ® SP2260 | | |
| Fourth EMA copolymer | EMA with 24% methacrylate | 10.0 gram/10 min |
| Westlake EMAC ® SP2268 | | |
| Fifth EMA copolymer | EMA with 20% methacrylate, plus | 6.0 gram/10 min |
| Westlake TYMAX ® GT7001 | maleic anhydride | |

*Melt index measured at 190 C. using a 2.16 kg weight

Modified EMA (APPEEL, TM of DuPont) is known to have versatile heat seal properties. However, the modified EMA faces challenges in processing due to edge weave, excessive neck-in and thermal decomposition of the plastic at the temperatures requires for high temperature extrusion coating. Also, its low processing temperature does not yield good bond to substrates such as tear resistant PET film. It was discovered that by blending the modified EMA with other EMA polymers, its neck-in and edge weave could be reduced, and it could be extruded at higher temperature which promotes better adhesion to PET. However, it was also discovered that not all kinds of EMA when blended would achieve better processing without sacrificing better end use properties such as improved heat seal and reduced blocking.

In the experiments, modified EMA (APPEEL) was blended with 24% methacrylate EMA (“first EMA copolymer” as identified in Table 1), and with 20% methacrylate EMA (“second EMA copolymer as identified in Table 1). A third EMA copolymer and fourth EMA copolymer are also identified in Table 1. Compared with modified EMA itself, the blends of modified EMA with the EMA copolymers generally gave good processing (melt curtain stability at higher temperature, low neck-in and edge weave) and better end use properties (e.g. heat sealing and non-blocking). Table 2 shows the results for the blends of modified EMA with the first EMA copolymer and second EMA copolymer. A chill roll release (CRR) was also added at 3% to avoid curtain adhesion to the chill roll. Best results were achieved when the modified EMA was blended with the second EMA copolymer (which had 20% methacrylate).

TABLE 2
Processing Conditions for Monolayer Blends

| | Processing | |
|---|---|---|
| | Melt | Processing |
| Monolayer Blend | Temp, ° F. | Observations |
| 97% MODIFIED EMA/3% CRR | 505 | Melt curtain not |
| 77% MODIFIED EMA | 533 | stable |
| 20% first EMA copolymer/3% CRR | | |
| 57% MODIFIED EMA | 546 | |
| 40% first EMA copolymer/3% CRR | | |
| 37% MODIFIED EMA | 546 | Melt curtain is |
| 60% first EMA copolymer/3% CRR | | stable |
| 17% MODIFIED EMA | 547 | |
| 80% first EMA copolymer/3% CRR | | |
| 77% MODIFIED EMA | 532 | |
| 20% second EMA copolymer/3% CRR | | |
| 57% MODIFIED EMA | 546 | |
| 40% second EMA copolymer/3% CRR | | |
| 37% MODIFIED EMA | 547 | |
| 60% second EMA copolymer/3% CRR | | |
| 17% MODIFIED EMA | 547 | |
| 80% second EMA copolymer/3% CRR | | |

Line speed: 165 feet per minute
Coat weight: 8.0 lbs/3000 sq. ft.

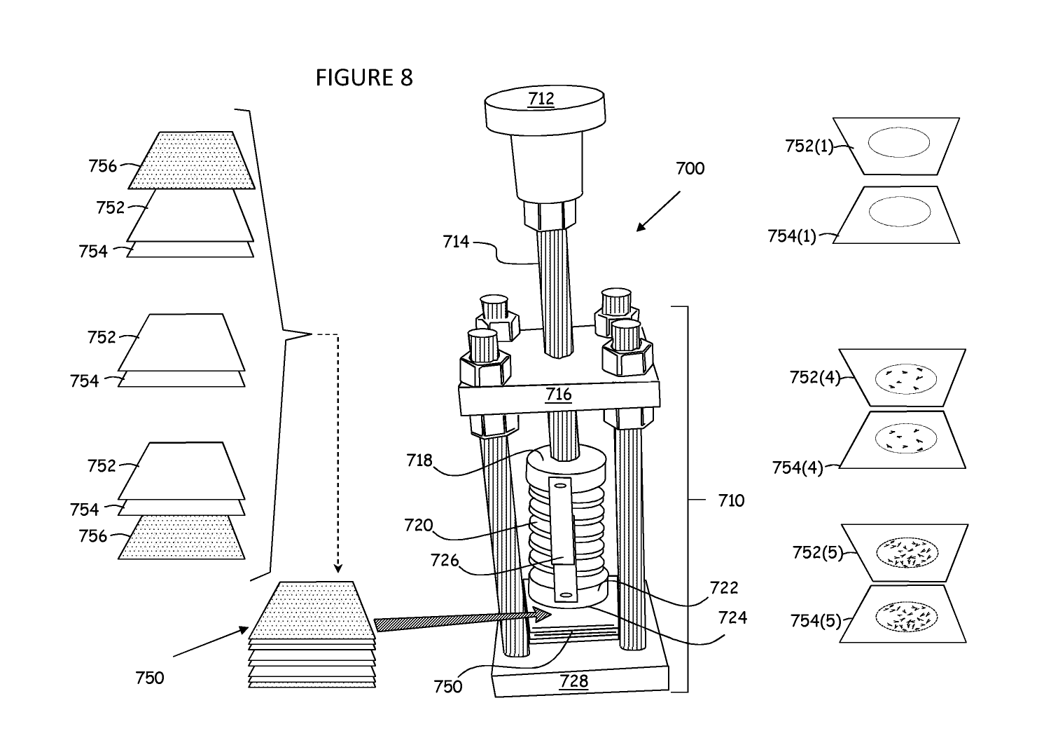

The heat seal and blocking performance of the various monolayer blends was measured and the results in Table 3 indicate that the blend of modified EMA (APPEAL) with the second EMA copolymer showed unusually high heat seal bond strength and better resistance to blocking, especially when the monolayer blend included 20-40% of the second EMA copolymer with 57-77% modified EMA (weight percent). The blocking ratings are described in more detail below with reference to Table 8 and FIG. 8.

TABLE 3
HEAT SEAL and BLOCKING for MONOLAYER BLENDS

| | Max Load (lbf) | | |
|---|---|---|---|
| | withstood by heat | | |
| | seal bond | | Blocking |
| | | Against | Rating after |
| | | PVC | 120° F., 24 hrs |
| Monolayer Blend | Self-Seal | Blister | and 60 psi |
| 97% MODIFIED EMA/3% CRR | 11.3 lbf | 8.8 lbf | 3.3 |
| 77% MODIFIED EMA/20% first EMA copolymer/3% CRR | Good sample was not | | |
| | obtained at this blend ratio | | |
| 57% MODIFIED EMA/40% first EMA copolymer/3% CRR | 11.1 lbf | 7.1 lbf | 5 |
| 37% MODIFIED EMA/60% FIRST EMA copolymer/3% CRR | 11.5 lbf | 6.0 lbf | 3.7 |
| 17% MODIFIED EMA/80% FIRST EMA copolymer/3% CRR | 10.0 lbf | 5.2 lbf | 3.5 |
| 77% MODIFIED EMA/20% SECOND EMA copolymer/3% CRR | 13.2 lbf | 9.5 lbf | 2.4 |
| 57% MODIFIED EMA/40% SECOND EMA copolymer/3% CRR | 11.3 lbf | 7.6 lbf | 2.2 |
| 37% MODIFIED EMA/60% SECOND EMA copolymer/3% CRR | 10.9 lbf | 4.9 lbf | 2 |
| 17% MODIFIED EMA/80% SECOND EMA copolymer/3% CRR | 9.7 lbf | 4.0 lbf | 2 |

Improved Processing with Co-Extrusion

Although the monolayer blends of modified EMA (APPEEL) with other EMAs showed significant improvement in processing behavior and in achieving good heat seal with reduced blocking, there was still a problem of high neck-in which would be expected to worsen at higher processing temperatures and line speeds. In an attempt to remedy these problems, multilayer co-extrusion was tested. Copolymers from the ethyl methyl acrylate (EMA) family were again chosen due to their high bonding to tear resistant PET film. The co-extrusion approach yielded surprising results of improved neck-in. However, edge encapsulation was still a problem as the EMA blend layer did not extend as far outward as the EMA copolymer layer. Since the EMA blend layer is important for heat sealing, the edges of the product substrate would have to trimmed and discarded.

A surprising discovery was then made when tests showed that both neck-in and edge encapsulation were both significantly improved by using a low melt index EMA copolymer as the coextruded layer nearest the substrate. Table 4 shows the improvement made in edge encapsulation and neck-in by using a particular EMA copolymer (the “third EMA copolymer”) as the substrate-contacting layer. The measurements were made with a ruler at the die opening.

TABLE 4
Improvement in Edge Encapsulation and Neck-In
with Co-Extruded Structures

| | Layer | | Edge | |
|---|---|---|---|---|
| Type of | nearest | | Encapsulation | |
| Structure | substrate | Outer Layer | (Inches) | Neck-In, % |
| Monolayer | None | 67% MODIFIED EMA | NA | 18.75 |
| | | 30% second EMA copolymer/3% | | |
| | | CRR | | |
| 2-Layer-A | first EMA | 67% MODIFIED EMA | 1.75 | 15.0 |
| | copolymer | 30% second EMA copolymer/3% | | |
| | | CRR | | |
| 2-Layer-B | third EMA | 67% MODIFIED EMA | 1.0 | 5.0 |
| | copolymer | 30% second EMA copolymer/3% | | |
| | | CRR | | |
| 2-Layer-C | fourth EMA | 67% MODIFIED EMA | 2.5 | — |
| | copolymer | 30% second EMA copolymer/3% | | |
| | | CRR | | |

Peel strength data are given in Table 5. The prior art hot melt structure 202A was compared with a monolayer EMA blend structure 203A and a two-layer EMA blend structure 203B. The EMA structures had self-seal peel strength similar to the hot melt, while sealing to blister materials (PVC, PETG, etc.) was acceptable although not quite as strong as with hot melt. The monolayer EMA structure 203A had slightly higher seal strength to blister materials than the two-layer EMA structure 203B. However, the two-layer structure exhibited less neck-down during extrusion. When extruded from an 18″ wide die at 330 fpm, the two-layer structure 203B yielded a 15.5″ coated width while the monolayer structure 203A yielded only a 14″ coated width.

TABLE 5
PEEL STRENGTH DATA

| Property | Structure 202A | Structure 203A | Structure 203B |
|---|---|---|---|
| Heat seal outer layer | hot melt | EMA blend | EMA blend |
| | E4050 DST | 57% modified EMA | 57% modified EMA |
| | | 40% EMA SP2207 | 40% EMA SP2207 |
| | | 3% chill roll release | 3% chill roll release |
| Heat seal inner | hot melt | (None) | EMA |
| layer/tie layer | HM1111B | | |
| Peel strength - self seal | 10 lbf | 10 lbf | 11 lbf |
| Peel strength on PVC | 8 lbf | 8 lbf | 6 lbf |
| Peel Strength on PETG | 7 lbf | 6.5 lbf | 4.5 lbf |
| Peel strength on APET | 7 lbf | 5 lbf | 4 lbf |
| Peel strength on RPET | 6 lbf | 5 lbf | 3.5 lbf |
| Peel strength on ACLAR | 2 lbf | 2 lbf | 2 lbf |

Substrate: 22 pt SBS with 1.44 mils* PET laminated onto the SBS (*1.44 mils = 144 gauge)
Heat sealing conditions: 350° F., 60 psi, for 3 seconds
T peeling: 1 square inch sealed area pulled at a rate of 1 inch per minute

The impact of tie layer material on the self-sealing properties was compared for the tie layer being LDPE or EMA. The tie layer is that layer contacting layer 125, for example contacting PET layer 125. The results are shown in Table 6. With the LDPE tie layer, delamination from the PET tear-resistant layer was seen regardless of pre-treatment or no pretreatment. With the EMA tie layer, delamination from the PET did not occur when ozone or ozone+corona pretreatment was used, and markedly higher peel strength (15 lbf instead of 6 lbf) was seen with the ozone-treated structure. Ozone, corona, flame, and combinations thereof, may be useful as pre-treatment methods.

The heat seal performance (peel strength) of the structure 204 with the EMA blend heat seal was compared against that of the prior hot-melt based structure 201. The results are shown in Table 7. The structure 204 had significantly better self-seal (14 lbs vs 10 lbs) and slightly poorer seal to PETG, with PVC and RPET sealing being roughly equal.

For the same two structures (EMA blend ‘204’ and hot melt ‘201’) the blocking performance was measured after samples were held at 130° F. and 60 psi pressure for 24 hours. As shown in Table 8, the EMA blend structure 204 with a blocking rating of 2.7 was superior to the hot melt structure 201 with a blocking rating of 4.6.

TABLE 6
EFFECT OF TIE LAYER

| Property | Structure 203B | Structure 204 |
|---|---|---|
| Heat seal outer layer | EMA blend | EMA blend |
| | (6 lb coat weight @ 538 F.) | (6 lb coat weight @ 538 F.) |
| | 57% modified EMA | 57% modified EMA |
| | 40% EMA SP2207 | 40% EMA SP2207 |
| | 3% chill roll release | 3% chill roll release |
| Heat seat inner layer | LDPE: NA217 | LDPE: NA217 |
| | (3 lb coat weight @ 577 F.) | (3 lb coat weight @ 580° F.) |
| Tie Layer | LDPE: NA217 | EMA: GT7001 |
| | (2 lb coat weight @ 610° F.) | (2 lb coat weight @ 609 F.) |
| Line Speed | 180 fpm | 180 fpm |
| Peel strength w/no treatment | 3 lbf (delaminated from PET) | 3 lbf (delaminated from PET) |
| Peel strength with ozone | 7 lbf (delaminated from PET) | 15 lbf |
| Peel strength ozone + corona | 13 lbf (delaminated from | 14 lbf |
| | PET) | |

Substrate: 22 pt SBS with 1.44 mils PET laminated onto the SBS
Pretreatment: See Table entries (none, ozone, or ozone + corona) onto the PET
Heat sealing conditions: 350° F., 60 psi, for 3 seconds
T peeling: 1 square inch sealed area pulled at a rate of 1 inch per minute

TABLE 7
Peel Strength of Structures 201 and 204

| | Structure 201 | Structure 204 |
|---|---|---|
| Property | Hot Melt | EMA blend |
| Heat seal out layer | Hot melt layer 2 | EMA blend |
| Heat seal inner layer | Hot melt layer 1 | LDPE |
| Tie Layer | | EMA |
| Peel strength self-seal | 10.5 lbf | 14 lbf |
| Peel strength to PVC | 7 lbf | 7 lbf |
| Peel strength to RPET | 4 lbf | 4 lbf |
| Peel strength to PETG | 7 lbf | 6 lbf |

Substrate: 22 pt SBS with 1.44 mils PET laminated onto the SBS
Pretreatment ozone + corona onto the PET
Heat sealing conditions: 350° F., 60 psi, for 3 seconds
T peeling: 1 square inch sealed area pulled at a rate of 1 inch per minute

Besides visible blocking (obvious adhesion of layers to one another), less visible material transfer can occur which is deleterious and can cause print mottle. An increase in water contact angle after a blocking test may be used as a measure of material transfer. The increase in water contact angle after the blocking test was measured on the print side and found to be 14 degrees for the EMA blend structure 204 as opposed to 42 degrees for the hot melt structure 201. This indicated that the EMA blend structure 204 has significantly less material transfer from the heat seal side to the print side.

TABLE 8
BLOCKING RESULTS

| | Structure 201 | Structure 204 |
|---|---|---|
| | (hot melt) | (EMA blend) |
| Increase in water contact angle | 42 degrees | 14 degrees |
| Average blocking rating | 4.6 | 2.7 |

Rating System
1 = no blocking; no surface change; no tack
2 = no blocking; small surface change; small tack
3 = no blocking; large surface change; large tack
4 = small blocking; small clay transfer
5 = blocking; fiber tear

The structure 204 as seen in FIG. 4 includes a 3-layer heat seal structure incorporating from the inside outward, an EMA layer 240, an LDPE layer 242, and an EMA blend layer 244. Compared with such a three-layer structure, a two-layer heat seal structure would likely be easier to process. Therefore, the three-layer structure 204 of FIG. 4 was compared against a two-layer structure 205 shown in FIG. 5, where the heat seal structure includes an EMA layer 250 and an EMA blend layer 254. The results are in Table 9. The two layer 205 structure overall did not have quite as strong a heat seal strength as the three-layer 204 structure. Blocking values for both the two-layer and three-layer structures were about 2, with the increase in contact angle being 14 degrees for structure 205 and 20 degrees for the 204 structure.

TABLE 9
ADDITIONAL PEEL STRENGTH DATA

| | Structure 205 | Structure 204 |
|---|---|---|
| Property | (2-layer co-ex) | (3-layer co-ex) |
| Heat seal outer layer | EMA blend | EMA blend |
| Heat seal inner layer | | LDPE |
| Tie Layer | EMA | EMA |
| Peel strength self-seal | 10 lbf | 12 lbf |
| Peel strength to PVC | 7 lbf | 7 lbf |
| Peel strength to APET | 3 lbf | 5 lbf |
| Peel strength to PETG | 5.5 lbf | 7 lbf |
| Blocking rating | 2 | 2 |
| Increase in | 14 degrees | 20 degrees |
| water contact angle | | |

Substrate: 22 pt SBS with 1.44 mils PET laminated onto the SBS
Pretreatment ozone + corona onto the PET
Heat sealing conditions: 350° F., 60 psi, for 3 seconds
T peeling: 1 square inch sealed area pulled at a rate of 1 inch per minute

An experiment was run to investigate the effect of sealing temperature on self-seal strength for the hot melt structure 201 and the EMA/EMA blend structure 205. Heat sealing temperatures from 250° F. to 400° F. were used. After heat sealing, samples with a one-square inch sealed area were pulled apart in a T-peeling test at the rate of one inch per minute. The results are shown in Table 10. At higher sealing temperatures, the seal strength decreased for the hot melt structure 201, while the seal strength remained fairly constant for the EMA/EMA blend structure 205.

Several of the structures in Tables 5 and 6 were 2-layer coextruded structures with 57% modified EMA, 40% EMA SP2207, and 3% chill roll release. Additional experiments were run with no chill roll release and having 70%, 85%, and 100% modified EMA. Results are shown in Table 11. Relative to the results seen in Table 9, peel strength generally improved, while blocking was slightly worse.

### Blocking Test Method

The blocking behavior of the samples was tested by evaluating the adhesion between the heat-seal side and the other side. A simplified illustration of the blocking test is shown in FIG. 8. The paperboard was cut into 2″×2″ square samples. Typically, 50 duplicates were tested for each condition, with each duplicate evaluating the blocking between a pair of samples 752, 754. (The results were averaged for each condition (e.g. the 50 values were averaged). Each pair was positioned with the heat seal side of one piece 752 contacting the opposite side of the other piece 754. The pairs were placed into a stack 750 with a spacer 756 at the top and bottom of the stack, the spacer being paperboard. The entire sample stack was placed into the test device 700 illustrated in FIG. 8.

The test device 700 includes a frame 710. An adjustment knob 712 is attached to a screw 714 which is threaded through the frame top 716. The lower end of screw 714 is attached to a plate 718 which bears upon a heavy coil spring 720. The lower end of the spring 720 bears upon a plate 722 whose lower surface 724 has an area of one square inch. A scale 726 enables the user to read the applied force (which is equal to the pressure applied to the stack of samples through the one-square-inch lower surface 724).

The stack 750 of samples is placed between lower surface 724 and the frame bottom 728. The knob 712 is tightened until the scale 726 reads the desired force of 60 lbf (60 psi applied to the samples). The entire device 700 including samples is then placed in an oven for 24 hours at 49° C. (120° F.) or 54° C. (130° F.). The device 700 is then removed from the test environment and cooled to room temperature. The pressure is then released and the samples removed from the device.

The samples were evaluated for tackiness and blocking by separating each pair of paperboard sheets. The results (averaged as noted above) were rated according to Table 8, with a 1 rating indicating no tendency to blocking.

Blocking damage is visible as fiber tear, which if present usually occurs with fibers pulling up from the clay-coated surface of samples 754.

For example, as symbolically depicted in FIG. 8, samples 752(1)/754(1) might be representative of a “1” blocking (as stated in Table 8, no blocking, no surface change, no tack). The circular shape in the samples indicates an approximate area that was under pressure, for instance about one square inch of the overall sample. A rating of “2” would indicate no blocking, but a small surface change and small tack. A rating of “3” would indicate no blocking but a large surface change, and a large tack. Samples 752(4)/754(4) might be representative of a “4” blocking rating (small blocking, small clay transfer). Samples 752(5)/754(5) might be representative of a “5” blocking rating (blocking and fiber tear). The depictions in FIG. 8 are only meant to approximately suggest the damage to such test samples, rather than showing a realistic appearance of the samples. After evaluating each sample (pair of sheets) out of a group, the (typically) 50 values were averaged to obtain a representative blocking rating.

### Peel Test Method

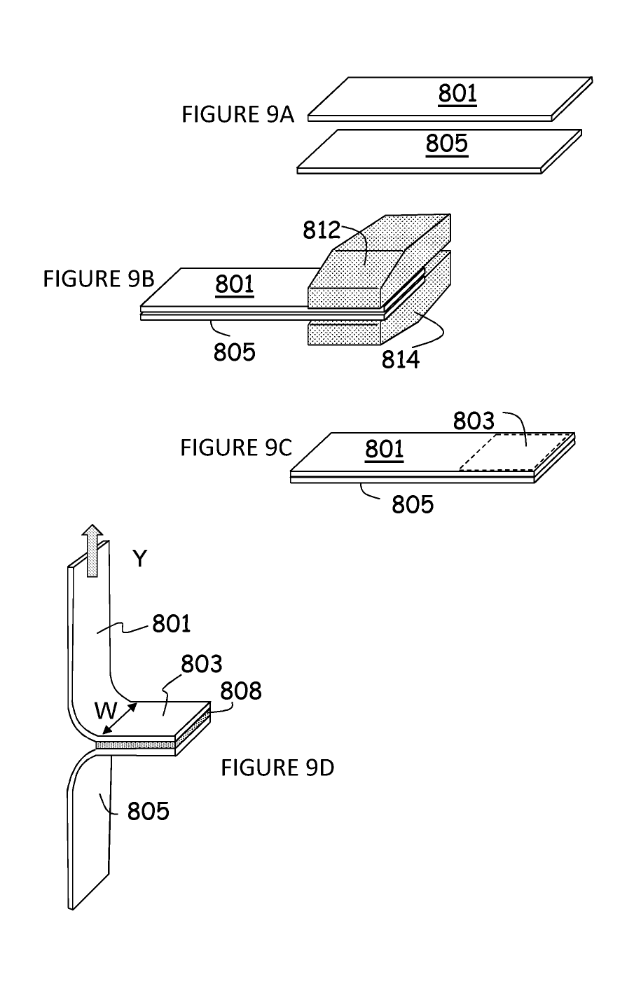

The board samples coated with heat seal material were tested for heat seal bond using a 90-degree T-peel test on an Instron 5900R machine. The method of ASTM 1876 may be referenced for this test. As depicted in FIG. 9A, a 3-inch by 1-inch sample 801 was cut from the board sample to be tested. Likewise, a 3-inch by 1-inch sample 805 was cut from whatever substrate the sample 801 was to be sealed to, for example PVC, APET, RPET, PETG, or even the same material as sample 801 (for self-seal tests). Next, as shown in FIG. 9B, a portion at one end of the samples 801, 805 was sealed together by placing between two surfaces 812, 814, with one or both surfaces being heated. A SencorpWhite Ceratek bar sealer was used in this case. Heat seal conditions were a sealing temperature of 350° F., a dwell time of 3 seconds, and a pressure or 60 psi. As shown in FIG. 9C, a 1 sq. inch area 803 was sealed (e.g. 1-inch by 1-inch). The sealed samples were then conditioned for 24 hrs at 73° F. and 50% relative humidity before testing in a 90-degree T-Peel mode using the Instron as schematically shown in FIG. 9D. The crosshead speed Y of the Instron was 1.0 inch/min. The width W of the samples was 1 inch. As samples 801 and 805 were pulled apart, peeling the heat seal bond 808 in the area 803, the maximum load (lbf) withstood by the bond during the test was recorded and reported as peel strength. The data was reported as an average of 5 samples.

### Water Contact Angle Test

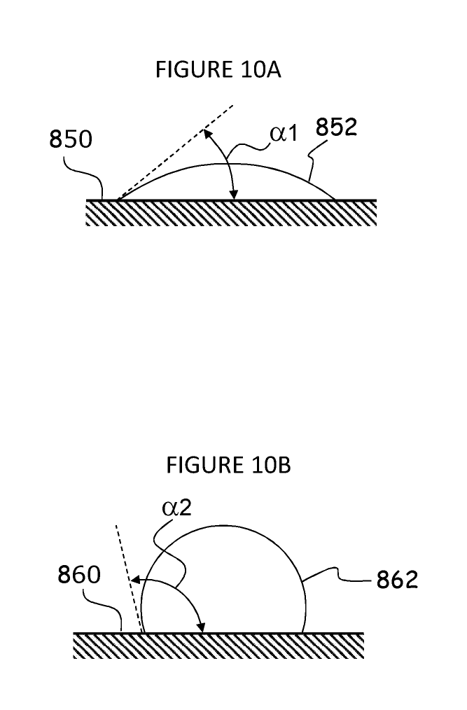

When the heat sealable surface of a sample contacts the clay/print surface of an adjoining sample, if blocking occurs it can affect the properties of the clay/print surface. As a quantitative measurement, the static contact angle with water was measured on the clay/print side of samples before and after the blocking test. A Rame-Hart Model 500 instrument with DROPimage Advanced v2.2 equipment was used for capturing water contact angle. For example, as shown in FIG. 10A, a 4.0 μl water drop 852 was put on the clay/print side of a sample 850 that had not been subjected to a blocking test, and the change in water contact angle α1 was measured over time. Three specimens per group were tested for contact angle. The total time for each test was 30 seconds, with one measurement taken every tenth of a second for 30 seconds. This gave 300 measurements in one test. The results reported herein are for the water contact angle α1 as measured 10 seconds after the water droplet 852 was applied to the surface. The clay or print side of paperboard 850 prior to a blocking test stayed clean and had a low contact angle α1, due to hydrophilic nature of the clay surface. A clean paperboard surface, that is, a low contact angle α1, is highly desirable for better print quality.

In contrast, during a blocking test, material sometimes transfers from the heat seal coating to the clay side, making it more hydrophobic. For example, as shown in FIG. 10B, when a 4.0 μl water drop 862 was placed on the clay/print side of a sample 860 after a blocking test, it could show an increased water contact angle α2. Usually, the greater the difference between angle α1 and angle α2, the more material transfer has occurred. The increase in water contact angle (α2 minus α1) is reported in Tables 8, 9, and 11.

TABLE 10
EFFECT OF SEALING TEMPERATURE

| | Self-seal performance | |
|---|---|---|
| Heat Seal | Structure 201 Hot melt | Structure 205 EMA/EMA blend |
| Temperature | Maximum load, lbf | Maximum load, lbf |
| 250 F. | 10.6 lbf | 9.3 lbf |
| 275 F. | 11.4 lbf | 12.7 lbf |
| 300 F. | 11.2 lbf | 13.2 lbf |
| 325 F. | 11.1 lbf | 12.8 lbf |
| 350 F. | 10.9 lbf | 11.5 lbf |
| 375 F. | 9.9 lbf | 12.8 lbf |
| 400 F. | 8.5 lbf | 12.8 lbf |

Substrate: 16 pt SBS with 1.44 mils PET laminated onto the SBS
Pretreatment ozone + corona onto the PET
Heat sealing conditions: 60 psi for 3 seconds
T peeling: 1 square inch sealed area pulled at a rate of 1 inch per minute

TABLE 11
PEEL STRENGTH DATA FOR ADDITIONAL BLENDS

| | Structure 205A | Structure 205B | Structure 205C |
|---|---|---|---|
| Property | (2 layer co-ex) | (2 layer co-ex) | (2 layer co-ex) |
| Heat seal | 70% modified EMA | 85% modified EMA | 100% modified |
| outer layer | 30% EMA SP2207 | 15% EMA SP2207 | EMA |
| | No chill roll release | No chill roll release | No chill roll |
| | | | release |
| Tie Layer | EMA | EMA | EMA |
| Peel strength | 13.5 lbf | 12.6 lbf | 12.0 lbf |
| self-seal | | | |
| Peel strength | 8.2 lbf | 9.6 lbf | 9.7 lbf |
| to PVC | | | |
| Peel strength | 4.5 lbf | 7.4 lbf | 8.9 lbf |
| to APET | | | |
| Peel strength | 6.4 lbf | 9.5 lbf | 8.6 lbf |
| to PETG | | | |
| Blocking | 3.0 | 3.5 | 4.0 |
| rating | | | |
| Increase in | 23 degrees | 22 degrees | 26 degrees |
| water contact | | | |
| angle | | | |

Substrate: 22 pt SBS with 1.44 mils PET laminated onto SBS
Pretreatment: ozone and corona
Heat sealing conditions: 350° F., 60 psi, for 3 seconds
T peeling: 1 sq inch sealed area pulled at 1 inch per minute

1. A laminate comprising:
A paperboard substrate having a first side and an opposing second side, having a print coating on the first side and having on the second side:
a heat sealable coating forming the laminate outer surface on the second side, wherein the heat sealable coating comprises a heat seal layer of (by weight) from 5 to 95% modified EMA, and 5 to 95% of an EMA copolymer.

2. The laminate of claim 1, wherein the heat seal layer contains no chill roll release.

3. The laminate of claim 1, wherein the heat seal layer comprises from 30 to 80% modified EMA, and 20 to 80% EMA copolymer.

4. The laminate of claim 3, wherein the heat seal layer comprises from 55 to 80% modified EMA, and 15 to 40% EMA copolymer.

5. The laminate of claim 1, wherein the EMA copolymer comprises from 8 to 28% methacrylate.

6. The laminate of claim 5, wherein the EMA copolymer comprises from 20 to 24% methacrylate.

7. The laminate of claim 1, further comprising an LDPE laminating layer between the paperboard substrate and the heat sealable coating.

8. The laminate of claim 7, further comprising a tear resistant layer between the LDPE laminating layer and the heat sealable coating.

9. The laminate of claim 8, further comprising a tie layer between the tear-resistant layer and the heat seal layer.

10. The laminate of claim 1, exhibiting no more than a small surface change and small tack after storing a stack of 50 sheets under 60 psi pressure in a 120° F. oven for 24 hours.

11. The laminate of claim 1, exhibiting no more than a small surface change and small tack after storing a stack of 50 sheets under 60 psi pressure in a 130° F. oven for 24 hours.

12. The laminate of claim 1, where the print coating exhibits an increase in water contact angle of less than 25 degrees when tested after storing a stack of 50 sheets under 60 psi pressure in a 120° F. oven for 24 hours.

13. The laminate of claim 1, where the print coating exhibits an increase in water contact angle of less than 25 degrees when tested after storing a stack of 50 sheets under 60 psi pressure in a 130° F. oven for 24 hours.

14. The laminate of claim 1, having a self-seal peel strength of at least 11.5 lbf, where the peel strength is measured after sealing together two pieces of laminate with a seal tool at 350° F. and 60 psi for 3 seconds, then peeling the two pieces apart by the T-peeling method for a 1 square inch sealed area pulled at a rate of 1 inch per minute.

15. The laminate of claim 1, having a self-seal peel strength of at least 11.5 lbf, where the self-seal peel strength is measured after sealing together two pieces of laminate with a seal tool at 400° F. and 60 psi for 3 seconds, then peeling the two pieces apart by the T-peeling method for a 1 square inch sealed area pulled at a rate of 1 inch per minute

16. The laminate of claim 1, having a peel strength of at least 2 lbf when sealed to a plastic sheet material, where the peel is measured after sealing the laminate to the plastic sheet material with a seal tool at 350° F. and 60 psi for 3 seconds, then peeling the two pieces apart by the T-peeling method for a 1 square inch sealed area pulled at a rate of 1 inch per minute.

17. The laminate of claim 16, wherein said peel strength is at least 3 lbf.

18. The laminate of claim 16, wherein said peel strength is at least 4 lbf.

19. The laminate of claim 16, wherein the plastic sheet material is selected from the group consisting of PET, APET, RPET, PETG, ACLAR, and PVC, and mixtures thereof.

20. The laminate of claim 1, wherein the heat seal layer weighs from 1 to 30 lb/3000 sq.ft.

21. The laminate of claim 20, wherein the heat seal layer weighs from 3 to 15 lb/3000 sq.ft.

22. The laminate of claim 21, wherein the heat seal layer weighs from 6 to 12 lb/3000 sq.ft.

23. The laminate of claim 8 wherein said tear resistant layer has a thickness from 0.5 mil to 5 mils.

24. The laminate of claim 1 wherein the paperboard substrate is one of a solid bleached sulfate and natural kraft board.

25. A laminate comprising:
A paperboard substrate having a first side and an opposing second side, having a print coating on the first side and having on the second side:
a heat sealable coating forming the laminate outer surface on the second side, wherein the heat sealable coating comprises a co-extruded heat seal layer nearest the outer surface and a coextruded inner layer, wherein the outer co-extruded heat seal layer comprises by weight 5 to 95% modified EMA, 5 to 95% of an EMA copolymer, and 0 to 5% chill roll release, and the inner co-extruded layer comprises a tie resin.

26. The laminate of claim 24, wherein the outer co-extruded heat seal layer comprises from 30 to 80% modified EMA, 20 to 80% EMA copolymer, and 0 to 5% chill roll release.

27. The laminate of claim 26, wherein the outer co-extruded heat seal layer comprises from 55 to 80% modified EMA, 15 to 40% EMA copolymer, and 0 to 5% chill roll release.

28. The laminate of claim 25, where the tie resin comprises at least one of EMA copolymer, LDPE, functionalized polyolefins, and functionalized EMA.

29. The laminate of claim 25, wherein the EMA copolymer comprises from 8 to 28% methacrylate.

30. The laminate of claim 29, wherein the EMA copolymer comprises from 20 to 24% methacrylate.

31. The laminate of claim 25, further comprising an LDPE laminating layer between the paperboard substrate and the heat sealable coating.

32. The laminate structure of claim 31, further comprising a tear resistant layer between the LDPE laminating layer and the heat sealable coating.

33. The laminate of claim 32, further comprising a tie layer between the tear-resistant layer and the heat sealable coating.

34. The laminate of claim 25, exhibiting no more than a small surface change and small tack after storing a stack of 50 sheets under 60 psi pressure in a 120° F. oven for 24 hours.

35. The laminate of claim 25, exhibiting no more than a small surface change and small tack after storing a stack of 50 sheets under 60 psi pressure in a 130° F. oven for 24 hours.

36. The laminate of claim 25, where the print coating exhibits an increase in water contact angle of less than 25 degrees when tested after storing a stack of 50 sheets under 60 psi pressure in a 120° F. oven for 24 hours.

37. The laminate of claim 25, where the print coating exhibits an increase in water contact angle of less than 25 degrees when tested after storing a stack of 50 sheets under 60 psi pressure in a 130° F. oven for 24 hours.

38. The laminate of claim 25, having a self-seal peel strength of at least 11.5 lbf, where the peel strength is measured after sealing together two pieces of laminate with a seal tool at 350° F. and 60 psi for 3 seconds, then peeling the two pieces apart by the T-peeling method for a 1 square inch sealed area pulled at a rate of 1 inch per minute.

39. The laminate of claim 25, having a self-seal peel strength of at least 11.5 lbf, where the self-seal peel strength is measured after sealing together two pieces of laminate with a seal tool at 400° F. and 60 psi for 3 seconds, then peeling the two pieces apart by the T-peeling method for a 1 square inch sealed area pulled at a rate of 1 inch per minute

40. The laminate of claim 25, having a peel strength of at least 2 lbf when sealed to a plastic sheet material, where the peel is measured after sealing the laminate to the plastic sheet material with a seal tool at 350° F. and 60 psi for 3 seconds, then peeling the two pieces apart by the T-peeling method for a 1 square inch sealed area pulled at a rate of 1 inch per minute.

41. The laminate of claim 40, wherein said peel strength is at least 3 lbf.

42. The laminate of claim 40, wherein said peel strength is at least 4 lbf.

43. The laminate of claim 40, wherein the plastic sheet material is selected from the group consisting of PET, APET, RPET, PETG, ACLAR, and PVC, and mixtures thereof.

44. The laminate of claim 25, wherein the outer-coextruded heat seal layer weighs from 1 to 30 lb/3000 sq.ft.

45. The laminate of claim 44, wherein the outer co-extruded heat seal layer weighs from 3 to 15 lb/3000 sq.ft.

46. The laminate of claim 45, wherein the outer co-extruded heat seal weighs from 6 to 12 lb/3000 sq.ft.

47. The laminate of claim 25, wherein the inner co-extruded layer has a coat weight of about 4 lb/3000 sq.ft. and the outer co-extruded heat seal layer has a coat weight of about 6 lb/3000 sq. ft.

48. The laminate of claim 32 wherein said tear resistant layer has a thickness from 0.5 mil to 5 mils.

49. The laminate of claim 25 wherein the paperboard substrate is one of a solid bleached sulfate and natural kraft board.

50. The laminate of claim 25, further comprising an intermediate co-extruded layer between the outer co-extruded heat seal layer and the inner co-extruded layer.
